(19) United States
(12) Patent Application Publication
(10) Pub. No.: US 2025/0147730 A1
(43) Pub. Date: May 8, 2025

(54) APPARATUSES AND METHODS FOR GENERATING PSEUDO-RANDOM NUMBER

(71) Applicant: Analog Devices, Inc., Wilmington, MA (US)

(72) Inventors: Enrique ALVAREZ FONTECILLA, Encinitas, CA (US); Paul S. WILKINS, Weston, MA (US)

(21) Appl. No.: 18/503,937

(22) Filed: Nov. 7, 2023

(51) Int. Cl. G06F 7/58

(52) U.S. Cl. CPC G06F 7/582

(57) ABSTRACT

Aspects of the present disclosure include a multiplexer having a plurality of input terminals each configured to receive a corresponding input value of a plurality of input values, an output terminal configured to output an output value of a white pseudo-random sequence and provide a delayed output value into a feedback loop, a feedback input terminal configured to receive a feedback value via the feedback loop, wherein the feedback value is the product of the delayed output value and a first value of a first pseudo-random sequence, and a select terminal configured to receive a second value of a second pseudo-random sequence and select, based on the second value, one of a combination of the plurality of input terminals and the feedback input terminal.

### BACKGROUND

A pseudo-random number generator may produce a sequence of numbers or symbols that cannot be reasonably predicted better than by random chance. In other words, the numbers or symbols of a sequence generated by a pseudo-random number generator may statistically have the same chance of occurrence. Random number generations may be achieved by a pseudo-random number generator (PRNG), which uses an algorithm to produce a seemingly random sequence of numbers or symbols. While the implementation of pseudo-random number generators with output sequences that take on a power-of-two number of values with equal probability is rather straightforward, that of pseudo-random number generators with output sequences that take on an arbitrary number of values is not necessarily simple.

### SUMMARY

The following presents a simplified summary of one or more aspects in order to provide a basic understanding of such aspects. This summary is not an extensive overview of all contemplated aspects, and is intended to neither identify key critical elements of all aspects nor delineate the scope of any or all aspects. Its sole purpose is to present some concepts of one or more aspects in a simplified form as a prelude to the more detailed description that is presented later.

Aspects of the present disclosure include a multiplexer having a plurality of input terminals each configured to receive a corresponding input value of a plurality of input values, wherein for every input value of the plurality of input values, there is an inverse input value such that the sum of the input value and the inverse input value is zero, an output terminal configured to output an output value of a white pseudo-random sequence and provide a delayed output value into a feedback loop, a feedback input terminal configured to receive a feedback value via the feedback loop, wherein the feedback value is the product of the delayed output value and a first value of a first pseudo-random sequence, and a select terminal configured to receive a second value of a second pseudo-random sequence and select, based on the second value, one of a combination of the plurality of input terminals and the feedback input terminal, wherein the multiplexer is configured to generate a next output value of the white pseudo-random sequence based on the plurality of input values, the feedback value, and the second value.

Aspects of the present disclosure include a method for generating a white pseudo-random sequence including receiving a plurality of input values, wherein for every input value of the plurality of input values, there is an inverse input value such that the sum of the input value and the inverse input value is zero, outputting an output value of the white pseudo-random sequence, providing a delayed output value into a feedback loop, receiving a feedback value via the feedback loop, wherein the feedback value is the product of the delayed output value and a first value of a first pseudo-random sequence, receiving a second value of a second pseudo-random sequence, selecting, based on the second value, one of a combination of the plurality of input terminals and the feedback input terminal, and generating a next output value of the white pseudo-random sequence based on the plurality of input values, the feedback value, and the second value.

Aspects of the present disclosure include a pseudo-random number generator including a multiplexer having a plurality of input terminals each configured to receive a corresponding input value of a plurality of input values, wherein for every input value of the plurality of input values, there is an inverse input value such that the sum of the input value and the inverse input value is zero, an output terminal configured to output an output value of a white pseudo-random sequence and provide a delayed output value into a feedback loop, a feedback input terminal configured to receive a feedback value via the feedback loop, wherein the feedback value is the product of the delayed output value and a first value of a first pseudo-random sequence, and a select terminal configured to receive a second value of a second pseudo-random sequence and select, based on the second value, one of a combination of the plurality of input terminals and the feedback input terminal, and a multiplier configured to receive the first value of the first pseudo-random sequence, receive the output value, multiply the first value of the first pseudo-random sequence and the output value, delay the result to generate the feedback value, and output the feedback value, wherein the multiplexer is configured to generate a next output value of the white pseudo-random sequence based on the plurality of input values, the feedback value, and the second value.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a first example of a PRNG circuit according to aspects of the present disclosure.

FIG. 2 illustrates a second example of a PRNG circuit according to aspects of the present disclosure.

FIG. 3 illustrates a method of generating a pseudo-random white sequence according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In some aspects, a pseudo-random number generators (PRNG) may be used in numerous applications. For example, a PRNG may be used for shuffling digital-to-analog converters (DACs), for dithering in analog-to-digital converters (ADCs), for random pattern generation in serializers/deserializers (SerDes), and so on. Typically, PRNG implementations make use of binary linear feedback shift registers (LFSRs). LFSRs may be used to generate white uniform sequences that take on values from a set with a power-of-two number of elements, but it is not straightforward to use them to generate white uniform K-ary sequences, where K>1 is an arbitrary integer and not necessarily a power of two.

Aspects of the present disclosure include a technique and a system to generate white, uniformly-distributed sequences that take on K different values, where K>1 is an arbitrary integer. The technique utilizes digital circuitry and may utilize binary LFSRs for implementing the PRNG. Specifically, aspects of the present disclosure include a digital circuit whose output is a white sequence that takes on K different values with equal probability. The circuit can be driven with the output of a binary LFSR. The output of the circuit is white, i.e., the output at sample time n is uncorrelated with the output at sample time m if n #m. The output is uniformly distributed and takes on values from a set of K values with probability 1/K.

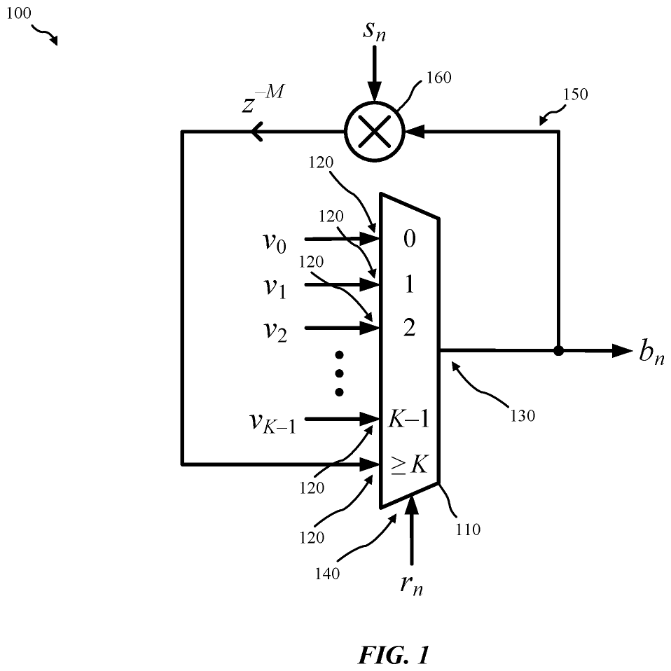

FIG. 1 illustrates a first example of a PRNG circuit 100 according to aspects of the present disclosure. In some aspects, the PRNG circuit 100 may include a multiplexer 110. The multiplexer 110 may include a plurality of input terminals 120 configured to receive a plurality of input values. Each of the plurality of input terminals 120 is configured to receive a corresponding input value of the plurality of input values. The multiplexer 110 may include an output terminal 130 configured to provide an output value. The multiplexer 110 may include a select terminal 140 configured to select one of the plurality of input terminals 120 based on a value of a second PRNG sequence rₙ. The PRNG circuit 100 may include a feedback loop 150 configured to feedback a delayed output value (as-is or modified) back into one of the plurality of input terminals 120 (particularly, the feedback terminal). The delayed output value may be the output value delayed by a particular delay. The delay may be one or more clock cycles, or other suitable time period according to aspects of the present disclosure. Specifically, the feedback loop 150 is configured to receive the delayed output value of a previous computation result of the multiplexer 110. For example, the feedback loop 150 at state n may be configured to receive the delayed output value of the multiplexer at state n−1. The PRNG circuit 100 may include a multiplier 160 configured to modify the delayed output value of the multiplexer 110 based on a value of a first PRNG sequence sₙ.

In some aspects of the present disclosure, K may be an integer larger than 1. The output sequence bₙ may be the white pseudo-random sequence generated by the PRNG circuit 100. The second PRNG sequence rₙ may be an R-bit independent random sequence that takes on values from the set {0, 1, . . . , 2^{R}−1} with probability ½^{R}. Here, R may the smallest integer such that R>log₂(K). In other aspects, R may be larger than log₂(K). The first PRNG sequence sₙ may be a one-bit independent random sequence that takes on values from the set {−1, 1} with probability ½ for each value. The vₖ input values are chosen so that for every vᵢ of the plurality of input values, there is a vⱼ that is also one of the plurality of input values such that vᵢ=−vⱼ. Here, the output sequence bₙ may output a pseudo-random sequence of the plurality of input values v₀, v₁, . . . v_{K-1} where each of the plurality of input values has a probability of 1/K of occurring.

During operation, in one aspect of the present disclosure, the multiplexer 110 may receive the plurality of input values via the plurality of input terminals 120. The multiplexer 110 may receive the second PRNG sequence rₙ at the select terminal 140. In one example, the second PRNG sequence rₙ may include values from the set {0, 1, . . . , 2^{R}−1} with probability ½^{R}. Depending on the value at the select terminal 140, the multiplexer 110 may select one of the corresponding input terminal of the plurality of input terminals 120 for output. For example, the first value from the set {0, 1, . . . , 2_{R}−1} (i.e., 0) may correspond to selecting the first terminal (thus, outputting the value v₀), the second value from the set (i.e., 1) may correspond to the second terminal (thus, outputting the value v₁), and so on and so forth. In one aspect of the present disclosure, one or more values from the set {0, 1, . . . , 2^{R}−1} may correspond to the feedback terminal of the plurality of terminals 120. For the selection of the feedback terminal, the multiplexer 110 may select the delayed output value, or the delayed output value multiplied by −1.

In certain aspects of the present disclosure, the multiplexer 110 may output the value selected based on the value at the select terminal 140. The multiplexer 110 may output the output value at the output terminal 130. The output value may be one of the values of the output sequence bₙ (i.e., the white pseudo-random sequence) generated by the PRNG circuit 100.

In some aspects, the multiplexer 110 may transmit a delayed output value back into the feedback loop 150. The multiplier 160 may receive the delayed output value and multiply the delayed output value by 1 or −1 (depending on the value of the first PRNG sequence sₙ). The first PRNG sequence sₙ may be a pseudo-random sequence that takes on values of 1 and −1. The product value (either the delayed output value or the delayed output value multiplied by −1) may be fed back into the feedback terminal of the plurality of input terminals 120.

A mathematical descriptions of the PRNG circuit 100 is provided below. Define α_{n,j} as:

$${α}_{n , j} = \{ \begin{matrix}1 , & if {r}_{n} = j , \\ 0 , & otherwise .\end{matrix}$$

Let R the smallest integer such that R>log₂(K) and suppose M=1 for simplicity. Then, bₙ can be written as:

$${b}_{n} = {\sum }_{j = 0}^{K - 1} {α}_{n , j} {v}_{j} + ( {\sum }_{j = K}^{{2}^{R} - 1} {α}_{n , j} ) {s}_{n - 1} {b}_{n - 1} .$$

The goal is to find P(bₙ=vₖ) for k=0, 1, . . . , K−1, i.e., the probability associated with the event bₙ=vₖ. For bₙ=vₖ there are two options: either rₙ=k, or rₙ>K−1 and also sₙ₋₁bₙ₋₁=vₖ.

Therefore, mathematically:

$$P ( {b}_{n} = {v}_{k} ) = P ( {α}_{n , k} = 1 ) + ( {\sum }_{j = K}^{{2}^{R} - 1} P ( {α}_{n , j} = 1 ) ) P ( {s}_{n - 1} {b}_{n - 1} = {v}_{k} ) .$$

For sₙ₋₁bₙ₋₁ to be equal to vₖ, either sₙ₋₁=1 and bₙ₋₁=vₖ, or sₙ₋₁=−1 and bₙ₋₁=−vₖ. The sₙ sequence is independent of bₙ hence:

$$P ( {b}_{n} = {v}_{k} ) = P ( {α}_{n , k} = 1 ) + ( {\sum }_{j = K}^{{2}^{R} - 1} P ( {α}_{n , j} = 1 ) ) P ( {s}_{n - 1} = 1 ) P ( {b}_{n - 1} = {v}_{k} ) + ( {\sum }_{j = K}^{{2}^{R} - 1} P ( {α}_{n , j} = 1 ) ) P ( {s}_{n - 1} = - 1 ) P ( {b}_{n - 1} = - {v}_{k} ) .$$

Furthermore, P(sₙ=1)=P(sₙ=−1)=½ and P(α_{n,j}=1)=2^{-R} for all j. Accordingly:

$$P ( {b}_{n} = {v}_{k} ) = \frac{1}{{2}^{R}} + \frac{1}{2} ( 1 - \frac{K}{{2}^{R}} ) ( P ( {b}_{n - 1} = {v}_{k} ) + P ( {b}_{n - 1} = - {v}_{k} ) ) .$$

Similarly, P(bₙ=−vₖ) may be computed to get a second equation. Doing this yields the following system of equations:

$$P ( {b}_{n} = {v}_{k} ) = \frac{1}{{2}^{R}} + \frac{1}{2} ( 1 - \frac{K}{{2}^{R}} ) ( P ( {b}_{n - 1} = {v}_{k} ) + P ( {b}_{n - 1} = - {v}_{k} ) )$$

$$P ( {b}_{n} = - {v}_{k} ) = \frac{1}{{2}^{R}} + \frac{1}{2} ( 1 - \frac{K}{{2}^{R}} ) ( P ( {b}_{n - 1} = - {v}_{k} ) + P ( {b}_{n - 1} = {v}_{k} ) ) .$$

The two equations above imply that P(bₙ=vₖ)=P(bₙ=−vₖ). Therefore:

$$P ( {b}_{n} = {v}_{k} ) = \frac{1}{{2}^{R}} + ( 1 - \frac{K}{{2}^{R}} ) P ( {b}_{n - 1} = {v}_{k} ) .$$

The previous result implies:

$$P ( {b}_{n} = {v}_{k} ) = \frac{1}{K} + {( 1 - \frac{K}{{2}^{R}} )}^{n} ( P ( {b}_{0} = {v}_{k} ) - \frac{1}{K} ) .$$

Given that 0<K/2^{R}<1, the second term on the right-hand side of the previous equation vanishes as n increases, so the probability density function (PDF) of bₙ converges to that of a uniformly distributed random variable that takes on K different values with equal probability. Accordingly, bₙ asymptotically converges to a uniform random process.

In some aspects, the power spectral density may be computed as follows. Assuming n>m, bₙbₘ can be computed as (suppose M=1 for simplicity):

$${b}_{n} {b}_{m} = ( {\sum }_{j = 0}^{K - 1} {α}_{n , j} {v}_{j} ) ( {\sum }_{j = 0}^{K - 1} {α}_{m , j} {v}_{j} ) + ( {\sum }_{j = 0}^{K - 1} {α}_{n , j} {v}_{j} ) ( {\sum }_{j = K}^{{2}^{R} - 1} {α}_{m , j} ) {s}_{m - 1} {b}_{m - 1} + ( {\sum }_{j = 0}^{K - 1} {α}_{m , j} {v}_{j} ) ( {\sum }_{j = K}^{{2}^{R} - 1} {α}_{n , j} ) {s}_{n - 1} {b}_{n - 1} + ( {\sum }_{j = K}^{{2}^{R} - 1} {α}_{n , j} ) ( {\sum }_{j = K}^{{2}^{R} - 1} {α}_{m , j} ) {s}_{n - 1} {b}_{n - 1} {s}_{m - 1} {b}_{m - 1} .$$

Given that n>m, α_{n,j} for all j is independent of all other variables. Accordingly, the expected value of bₙbₘ, denoted as E{bₙbₘ}, is given by:

$$E \{ {b}_{n} {b}_{m} \} = E \{ {\sum }_{j = 0}^{K - 1} {α}_{n , j} {v}_{j} \} E \{ {\sum }_{j = 0}^{K - 1} {α}_{m , j} {v}_{j} \} + E \{ {\sum }_{j = 0}^{K - 1} {α}_{n , j} {v}_{j} \} E \{ ( {\sum }_{j = K}^{{2}^{R} - 1} {α}_{m , j} ) {s}_{m - 1} {b}_{m - 1} \} + E \{ {\sum }_{j = K}^{{2}^{R} - 1} {α}_{n , j} \} E \{ ( {\sum }_{j = 0}^{K - 1} {α}_{m , j} {v}_{j} ) {s}_{n - 1} {b}_{n - 1} \} + E \{ {\sum }_{j = K}^{{2}^{R} - 1} {α}_{n , j} \} E \{ ( {\sum }_{j = K}^{{2}^{R} - 1} {α}_{m , j} ) {s}_{n - 1} {b}_{n - 1} {s}_{m - 1} {b}_{m - 1} \} .$$

Furthermore, as n>m, then sₘ₋₁ is independent of α_{m,j} for all j and bₘ₋₁, and sₙ₋₁ is independent of α_{m,j} for all j, bₙ₋₁ and bₘ₋₁. Hence, E{bₙbₘ} can be written as:

$$E \{ {b}_{n} {b}_{m} \} = E \{ {\sum }_{j = 0}^{K - 1} {α}_{n , j} {v}_{j} \} E \{ {\sum }_{j = 0}^{K - 1} {α}_{m , j} {v}_{j} \} + E \{ {s}_{m - 1} \} E \{ {\sum }_{j = 0}^{K - 1} {α}_{n , j} {v}_{j} \} E \{ ( {\sum }_{j = K}^{{2}^{R} - 1} {α}_{m , j} ) {b}_{m - 1} \} + E \{ {s}_{n - 1} \} E \{ {\sum }_{j = K}^{{2}^{R} - 1} {α}_{n , j} \} E \{ ( {\sum }_{j = 0}^{K - 1} {α}_{m , j} {v}_{j} ) {b}_{n - 1} \} + E \{ {s}_{n - 1} \} E \{ {\sum }_{j = K}^{{2}^{R} - 1} {α}_{n , j} \} E \{ ( {\sum }_{j = K}^{{2}^{R} - 1} {α}_{m , j} ) {b}_{n - 1} {s}_{m - 1} {b}_{m - 1} \} .$$

The definition of sₙ implies that E{sₙ} for all n, thus:

$$E \{ {b}_{n} {b}_{m} \} = E \{ {\sum }_{j = 0}^{K - 1} {α}_{n , j} {v}_{j} \} E \{ {\sum }_{j = 0}^{K - 1} {α}_{m , j} {v}_{j} \} .$$

Given that:

$$E \{ {\sum }_{j = 0}^{K - 1} {α}_{n , j} {v}_{j} \} = {\sum }_{j = 0}^{K - 1} E \{ {α}_{n , j} \} {v}_{j} = \frac{1}{{2}^{R}} {\sum }_{j = 0}^{K - 1} {v}_{j} = 0 .$$

Therefore:

E{bₙbₘ}=0.

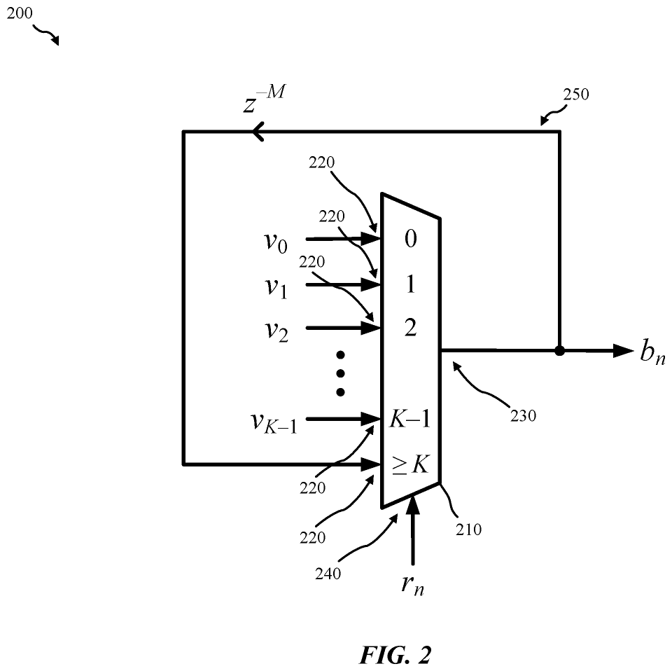

FIG. 2 illustrates a second example of a PRNG circuit 200 according to aspects of the present disclosure in which the output sequence is uniformly distributed but not white. In some aspects, the PRNG circuit 200 may include a multiplexer 210. The multiplexer 210 may include a plurality of input terminals 220 configured to receive a plurality of input values. The multiplexer 210 may include an output terminal 230 configured to provide an output value. The multiplexer 210 may include a select terminal 240 configured to select one of the plurality of input terminals 220 based on a value of a second PRNG sequence rₙ. The PRNG circuit 100 may include a feedback loop 250 configured to feedback a delayed output value back into one of the plurality of input terminals 220 (particularly, the feedback terminal).

In some aspects of the present disclosure, K may be an integer larger than 1. The output sequence bₙ may be the pseudo-random sequence generated by the PRNG circuit 200. The PRNG sequence rₙ may be an R-bit independent random sequence that takes on values from the set {0, 1, . . . , 2^{R}−1} with probability ½^{R}. Here, R may the smallest integer such that R>log₂(K). In other aspects, R may be larger than log₂(K). Here, the output sequence bₙ may output a pseudo-random sequence of the plurality of input values v₀, v₁, . . . v_{K-1} where each of the plurality of input values has a probability of 1/K of occurring.

During operation, in one aspect of the present disclosure, the multiplexer 210 may receive the plurality of input values via the plurality of input terminals 220. The multiplexer 210 may receive the PRNG sequence rₙ at the select terminal 240. In one example, the PRNG sequence rₙ may include values from the set {0, 1, . . . , 2^{R}−1} with probability ½^{R}. Depending on the value at the select terminal 240, the multiplexer 210 may select one of the corresponding input terminal of the plurality of input terminals 220 for output. For example, the first value from the set {0, 1, . . . , 2^{R}−1} (i.e., 0) may correspond to selecting the first terminal (thus, outputting the value v₀), the second value from the set (i.e., 1) may correspond to the second terminal (thus, outputting the value v₁), and so forth and so on. In one aspect of the present disclosure, one value from the set {0, 1, . . . , 2^{R}−1} may correspond the feedback terminal of the plurality of terminals 220. For the selection of the feedback terminal, the multiplexer 210 may select the delayed output value.

In certain aspects of the present disclosure, the multiplexer 210 may output the value selected based on the value at the select terminal 240. The multiplexer 210 may output the output value at the output terminal 230. The output value may be one of the values of the output sequence bₙ (i.e., the pseudo-random sequence) generated by the PRNG circuit 200.

In some aspects, the multiplexer 210 may transmit a delayed output value back into the feedback loop 250. The output value may be fed back into the feedback terminal of the plurality of input terminals 220 after a particular delay.

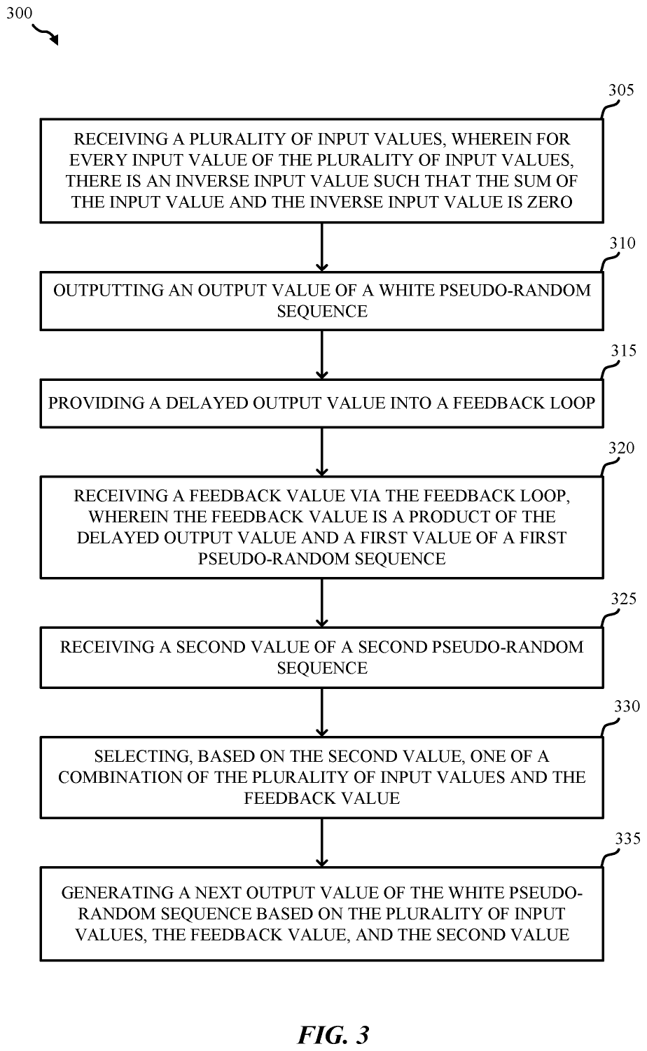

FIG. 3 illustrates a method 300 of generating a white pseudo-random sequence according to aspects of the present disclosure. The method 300 may be performed by the PRNG circuit 100 and/or one or more subcomponents of the PRNG circuit 100.

At 305, the method 300 may receive a plurality of input values, wherein for every input value of the plurality of input values, there is an inverse input value such that the sum of the input value and the inverse input value is zero. The multiplexer 110 may be configured to, and/or provide means for, receiving a plurality of input values, wherein for every input value of the plurality of input values, there is an inverse input value such that the sum of the input value and the inverse input value is zero.

At 310, the method 300 may output an output value of the pseudo-random sequence. The multiplexer 110 may be configured to, and/or provide means for, outputting an output value of the white pseudo-random sequence.

At 315, the method 300 may provide a delayed output value into a feedback loop. The multiplexer 110 may be configured to, and/or provide means for, providing a delayed output value into a feedback loop.

At 320, the method 300 may receive a feedback value via the feedback loop, wherein the feedback value is a product of the delayed output value and a first value of a first pseudo-random sequence. The multiplexer 110 may be configured to, and/or provide means for, receiving a feedback value via the feedback loop, wherein the feedback value is a product of the delayed output value and a first value of a first pseudo-random sequence.

At 325, the method 300 may receive a second value of a second pseudo-random sequence. The multiplexer 110 may be configured to, and/or provide means for, receiving a second value of a second pseudo-random sequence.

At 330, the method 300 may select, based on the second value, one of a combination of the plurality of input values and the feedback value. The multiplexer 110 may be configured to, and/or provide means for, selecting, based on the second value, one of a combination of the plurality of input values and the feedback value.

At 335, the method 300 may generate a next output value of the white pseudo-random sequence based on the plurality of input values, the feedback value, and the second value. The multiplexer 110 may be configured to, and/or provide means for, generating a next output value of the white pseudo-random sequence based on the plurality of input values, the feedback value, and the second value.

Aspects of the present disclosure include a multiplexer having a plurality of input terminals each configured to receive a corresponding input value of a plurality of input values, wherein for every input value of the plurality of input values, there is an inverse input value such that the sum of the input value and the inverse input value is zero, an output terminal configured to output an output value of a pseudo-random sequence and provide a delayed output value into a feedback loop, a feedback input terminal configured to receive a feedback value via the feedback loop, wherein the feedback value is the product of the delayed output value and a first value of a first pseudo-random sequence, and a select terminal configured to receive a second value of a second pseudo-random sequence and select, based on the second value, one of a combination of the plurality of input terminals and the feedback input terminal, wherein the multiplexer is configured to generate a next output value of the white pseudo-random sequence based on the plurality of input values, the feedback value, and the second value.

Aspects of the present disclosure include the multiplexer above, wherein the pseudo-random sequence includes a random uniform distribution of the plurality of input values.

Aspects of the present disclosure include any of the multiplexers above, further comprises a multiplier configured to receive the first value of the first pseudo-random sequence, receive the delayed output value, multiply the first value of the first pseudo-random sequence and the delayed output value to generate the feedback value, and output the feedback value.

Aspects of the present disclosure include any of the multiplexers above, wherein the first value of the first pseudo-random sequence is 1 or −1 with substantially equal probability.

Aspects of the present disclosure include any of the multiplexers above, wherein each value of the second pseudo-random sequence includes R number of bits and each value has substantially a chance of 2^{-R} of occurring in the second pseudo-random sequence.

Aspects of the present disclosure include any of the multiplexers above, wherein the number of the plurality of input values is K and each input value of the plurality of input values has substantially a chance of K⁻¹ of occurring in the white pseudo-random output sequence.

Aspects of the present disclosure include a method for generating a white pseudo-random sequence including receiving a plurality of input values, wherein for every input value of the plurality of input values, there is an inverse input value such that the sum of the input value and the inverse input value is zero, outputting an output value of the white pseudo-random sequence, providing a delayed output value into a feedback loop, receiving a feedback value via the feedback loop, wherein the feedback value is a product of the delayed output value and a first value of a first pseudo-random sequence, receiving a second value of a second pseudo-random sequence, selecting, based on the second value, one of a combination of the plurality of input terminals and the feedback input terminal, and generating a next output value of the white pseudo-random sequence based on the plurality of input values, the feedback value, and the second value.

Aspects of the present disclosure include the method above, wherein the white pseudo-random sequence includes a random uniform distribution of the plurality of input values.

Aspects of the present disclosure include any of the methods above, wherein receiving the feedback value further comprises receiving the first value of the first pseudo-random sequence and multiply the first value of the first pseudo-random sequence and the delayed output value to generate the feedback value.

Aspects of the present disclosure include any of the methods above, wherein the first value of the first pseudo-random sequence is 1 or −1 with substantially equal probability.

Aspects of the present disclosure include any of the methods above, wherein each value of the second pseudo-random sequence includes R number of bits and each value has substantially a chance of 2^{-R} of occurring in the second pseudo-random sequence.

Aspects of the present disclosure include any of the methods above, wherein the number of the plurality of input values is K and each input value of the plurality of input values has substantially a chance of K⁻¹ of occurring in the white pseudo-random output sequence.

Aspects of the present disclosure include a pseudo-random number generator including a multiplexer having a plurality of input terminals each configured to receive a corresponding input value of a plurality of input values, wherein for every input value of the plurality of input values, there is an inverse input value such that the sum of the input value and the inverse input value is zero, an output terminal configured to output an output value of a white pseudo-random sequence and provide a delayed output value into a feedback loop, a feedback input terminal configured to receive a feedback value via the feedback loop, wherein the feedback value is a product of the delayed output value and a first value of a first pseudo-random sequence, and a select terminal configured to receive a second value of a second pseudo-random sequence and select, based on the second value, one of a combination of the plurality of input terminals and the feedback input terminal, and a multiplier configured to receive the first value of the first pseudo-random sequence, receive the delayed output value, multiply the first value of the first pseudo-random sequence and the delayed output value to generate the feedback value, and output the feedback value, wherein the multiplexer is configured to generate a next output value of the white pseudo-random sequence based on the plurality of input values, the feedback value, and the second value.

Aspects of the present disclosure include the pseudo-random number generator above, wherein the white pseudo-random sequence includes a random uniform distribution of the plurality of input values.

Aspects of the present disclosure include any of the pseudo-random number generators above, wherein the first value of the first pseudo-random sequence is 1 or −1 with substantially equal probability.

Aspects of the present disclosure include any of the pseudo-random number generators above, wherein each value of the second pseudo-random sequence includes R number of bits and each value has substantially a chance of 2^{-R} of occurring in the second pseudo-random sequence.

Aspects of the present disclosure include any of the pseudo-random number generators above, wherein the number of the plurality of input values is K and each input value of the plurality of input values has substantially a chance of K⁻¹ of occurring in the white pseudo-random output sequence.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. For example, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined in other examples. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A multiplexer, comprising:
a plurality of input terminals each configured to receive a corresponding input value of a plurality of input values, wherein for every input value of the plurality of input values, there is an inverse input value such that a sum of the input value and the inverse input value is zero;
an output terminal configured to output an output value of a white pseudo-random sequence and provide a delayed output value to a feedback loop;
a feedback input terminal configured to receive a feedback value via the feedback loop, wherein the feedback value is a product of the delayed output value and a first value of a first pseudo-random sequence; and
a select terminal configured to:
receive a second value of a second pseudo-random sequence, and
select, based on the second value, one of a combination of the plurality of input terminals and the feedback input terminal;
the multiplexer being configured to generate a next output value of the white pseudo-random sequence based on the plurality of input values, the feedback value, and the second value.

2. The multiplexer of claim 1, wherein the white pseudo-random sequence includes a random uniform distribution of the plurality of input values.

3. The multiplexer of claim 1, further comprises a multiplier configured to:
receive the first value of the first pseudo-random sequence;
receive the delayed output value;
multiply the first value of the first pseudo-random sequence and the delayed output value to generate the feedback value; and
output the feedback value.

4. The multiplexer of claim 1, wherein the first value of the first pseudo-random sequence is 1 or −1 with substantially equal probability.

5. The multiplexer of claim 1, wherein each value of the second pseudo-random sequence includes R number of bits and each value has substantially a chance of 2^{-R} of occurring in the second pseudo-random sequence.

6. The multiplexer of claim 1, wherein a number of the plurality of input values is K and each input value of the plurality of input values has substantially a chance of K⁻¹ of occurring in the white pseudo-random output sequence.

7. A method for generating a white pseudo-random sequence, comprising:
receiving a plurality of input values, wherein for every input value of the plurality of input values, there is an inverse input value such that a sum of the input value and the inverse input value is zero;
outputting an output value of the white pseudo-random sequence;
providing a delayed output value into a feedback loop;
receiving a feedback value via the feedback loop, wherein the feedback value is a product of the delayed output value and a first value of a first pseudo-random sequence;
receiving a second value of a second pseudo-random sequence,
selecting, based on the second value, one of a combination of the plurality of input values and the feedback value; and
generating a next output value of the white pseudo-random sequence based on the plurality of input values, the feedback value, and the second value.

8. The method of claim 7, wherein the white pseudo-random sequence includes a random uniform distribution of the plurality of input values.

9. The method of claim 7, wherein receiving the feedback value further comprises:
receive the first value of the first pseudo-random sequence; and
multiply the first value of the first pseudo-random sequence and the delayed output value to generate the feedback value.

10. The method of claim 7, wherein the first value of the first pseudo-random sequence is 1 or −1 with substantially equal probability.

11. The method of claim 8, wherein each value of the second pseudo-random sequence includes R number of bits and each value has substantially a chance of 2^{-R} of occurring in the second pseudo-random sequence.

12. The method of claim 8, wherein a number of the plurality of input values is K and each input value of the plurality of input values has substantially a chance of K⁻¹ of occurring in the white pseudo-random output sequence.

13. A pseudo-random number generator, comprising:
a multiplexer including:
a plurality of input terminals each configured to receive a corresponding input value of a plurality of input values, wherein for every input value of the plurality of input values, there is an inverse input value such that a sum of the input value and the inverse input value is zero;
an output terminal configured to output an output value of a white pseudo-random sequence and provide a delayed output value into a feedback loop;
a feedback input terminal configured to receive a feedback value via the feedback loop, wherein the feedback value is a product of the delayed output value and a first value of a first pseudo-random sequence; and
a select terminal configured to:
receive a second value of a second pseudo-random sequence, and
select, based on the second value, one of a combination of the plurality of input terminals and the feedback input terminal;
wherein the multiplexer is configured to generate the output value of the white pseudo-random sequence based on the plurality of input values, the feedback value, and the second value; and
a multiplier configured to:
receive the first value of the first pseudo-random sequence;
receive the delayed output value;
multiply the first value of the first pseudo-random sequence and the delayed output value to generate the feedback value; and
output the feedback value;
the multiplexer being configured to generate a next output value of the white pseudo-random sequence based on the plurality of input values, the feedback value, and the second value.

14. The pseudo-random number generator of claim 13, wherein the white pseudo-random sequence includes a random uniform distribution of the plurality of input values.

15. The pseudo-random number generator of claim 13, wherein the first value of the first pseudo-random sequence is 1 or −1 with substantially equal probability.

16. The pseudo-random number generator of claim 15, wherein each value of the second pseudo-random sequence includes R number of bits and each value has substantially a chance of 2^{-R} of occurring in the second pseudo-random sequence.

17. The pseudo-random number generator of claim 15, wherein a number of the plurality of input values is K and each input value of the plurality of input values has substantially a chance of K⁻¹ of occurring in the white pseudo-random output sequence.
